(19) United States
(12) Patent Application Publication
(10) Pub. No.: US 2005/0083595 A1
(43) Pub. Date: Apr. 21, 2005

(54) Panorama side view mirror

(76) Inventor: Lloyd C. Mostrom, Arlington, VA (US)

Correspondence Address: Lloyd C. Mostrom, 910 North Montana Street, Arlington, VA, 22205-1622, US

(21) Appl. No.: 10/687,653

(22) Filed: Oct. 20, 2003

(51) Int. Cl. G02B 5/08; G02B 5/10

(52) U.S. Cl. 359/869; 359/838

(57) ABSTRACT

The PANORAMA SIDE VIEW MIRRORS are designed to give the driver of a vehicle a convenient image view of any object present or approaching in the side-rear quadrant on either side of the vehicle on which mounted. They replace the present side view mirrors which have ‘blind spots’ in certain sectors of the side-rear quadrant on either side of the vehicle on which mounted. Each panorama side view mirror may consist of three or more adjacent flat mirrors to reflect adjacent sectors of the side-rear quadrant on the side of the vehicle on which mounted or each mirror may consist of a single convex contoured mirrored surface reflecting an image view of the entire side-rear quadrant of the side on which mounted. The mirror or assembly of mirrors on each side of the vehicle will be mounted on a ball and socket equipped bracket to permit adjustment of the mirror angles to suit the viewing comfort of the driver of the vehicle.

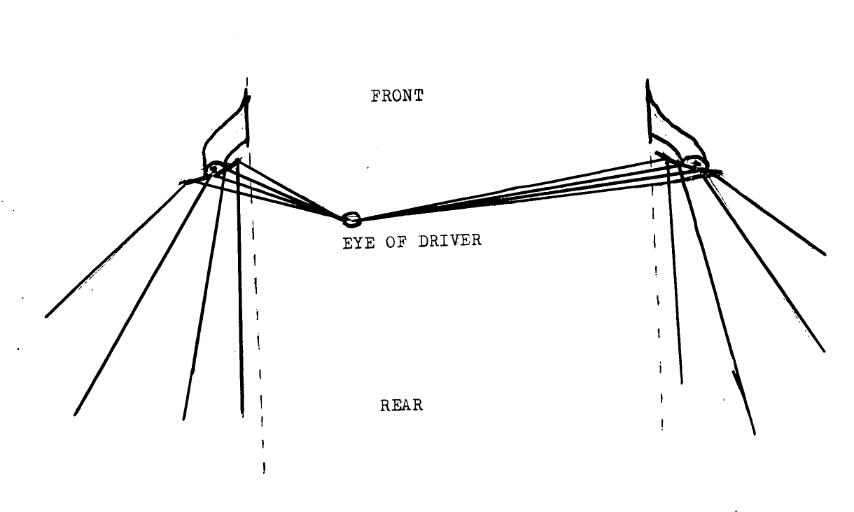

### CROSS REFERENCE TO RELATED APPLICATION

Provisional application submitted Aug. 28, 2003

Patent application Ser. No. 10/441/160 dtd May 20, 2003

### STATEMENT REGARDING FEDERALLY SPONSORED RESEARCH

Not applicable

### REFERENCE TO MICROFICHE

Not applicable

### BACKGROUND OF THE INVENTION

This invention is in response to the frequency of automobile accidenta due to ‘blind spots’ in the present side view mirrors on automobiles and the consequent need for the drivers to look to the sides over their shoulders to look for the presence of any upcoming vehicles thus momentarily losing sight of any obstacles ahead. The enlargement ‘patch’ mirrors currently available tend to distort the distance of any vehicle present in that area and thus giving the driver a false sense of security.

### BRIEF SUMMARY OF THE INVENTION

This invention is provided to give the driver of an automobile a ready comprehensive view within the forward range of vision to gain a mirror view to the rear and sides of his/her vehicle without the distraction of looking back over the shoulder to see if any other vehicle is appproaching or running beside the basic vehicle thus interrupting the view of any vehicle or other obstruction to the front.

### BRIEF DESCRIPTION OF THE INVENTION

This invention consists of replacement mirrors to be installed on each side of the car. Each mirror is flat vertically and basically convex horizontally to give the driver an instant view of the entire spectrum to the rear and sides of the automobile being driven without the need to look back over his/her shoulder thus momentarily losing sight of any vehicle or other obstruction in front.

### DETAILED DESCRIPTION OF THE INVENTION

The basic horizontal contour of the mirrors is convex to provide mirror images covering all sectors to the rear and each side of the vehicle being driven. Each side mirror segment is flat vertically and may consist of multiple flat mirrors set in a concave array giving successive views of the several sectors to the rear and sides of the automobile being driven or each mirror may consist of a single horizontally convex mirror covering the same sectors to give the driver an instant image views of any approaching vehicle or other obstruction without distracting the view forward.

### SUMMARY OF THE INVENTION

The automobile panorama side view mirror consists of a side view mirror that is flat vertically and basically convex (or concave) horizontally,

The panorama side view mirror may also consist of a series of side by side flat mirrors set at fixed angles so as to reflect adjoining sectors to the rear and side of the vehcle to which attached

This mirror will reflect images of approaching vehicles in a wide range of sectors to the rear and side of the basic vehicle.

This mirror is designed so that right and left adaptions are installed on the two sides of the vehicle.

This mirror is designed to replace the present automobile rear view side mirrors.

These mirrors will enable the driver of an automobile to see a mirror view image of any vehicle present or approaching from behind or beside the basic vehicle without turning his/her head to look over his/her shoulder.

1. Will increase safety in automobile traffic by giving the drivers a better view of any vehicle or other obstruction in the present side miror ‘blind areas’ of the basic vehicle withput diverting the drever's attention from possible obstructions to the front of the vehicle

2 Will ease the tension on the drivers by giving him/her a quick view of any vehicles coming up beside his/her vehicle without the need to look back over the driver's shouolder thus diverting the driver's atention from the front view of the driver

3. Relieve the driver of the need to divert his/her attention from the front to the side to determine of any vehicle is beside him/her in the blind spot of current mirrors
